(19) United States
(12) Patent Application Publication
(10) Pub. No.: US 2011/0093125 A1
(43) Pub. Date: Apr. 21, 2011

(54) Electricity Management System and Method

(75) Inventors: Ulrich C. Schoeman, Stellenbosch (ZA); Bernard Hein Forrer, Somerset West (ZA)

(73) Assignee: Klaprops 299 (Proprietary) Limited, Johannesburg (ZA)

(21) Appl. No.: 12/861,997

(22) Filed: Aug. 24, 2010

(30) Foreign Application Priority Data
Aug. 24, 2009 (ZA) 2009/05873

(51) Int. Cl. G06F 1/32

(52) U.S. Cl. 700/291; 700/295

(57) ABSTRACT

A method for managing electricity usage of an electrical system comprises providing an electricity usage budget for the electrical system, the electricity usage budget being associated with at least a desired or predetermined electricity usage in a predetermined time period. Electricity usage in the electrical system is monitored periodically at time intervals corresponding to the predetermined time period. The monitored electricity usage is compared to the electricity usage budget or information associated therewith for the predetermined time period. Finally, electricity use within the electrical system is limited for a predetermined limitation time period according to predetermined rules if the monitored electrical usage is greater than the electrical usage budget for the predetermined time period.

### BACKGROUND OF THE INVENTION

THIS invention relates to a method and system for managing electricity usage of an electrical system.

Increased electricity consumption has resulted in increased costs for electricity and has placed great pressures on electricity infrastructures. This is often undesirable especially for businesses and households which typically have to face the brunt of electricity cost escalations.

It is therefore an object of the present invention to provide a method and system at least to ameliorate the effect of escalating costs of electricity and to manage electricity usage more conveniently and easily with minimal impact on operations of a business for example.

### SUMMARY OF THE INVENTION

According to a first aspect of the invention there is provided a method for managing electricity usage of an electrical system, the method comprising:
providing an electricity usage budget for the electrical system, the electricity usage budget being associated with at least a desired or predetermined electricity usage in a predetermined time period;
monitoring electricity usage in the electrical system periodically at time intervals corresponding to the predetermined time period;
comparing the monitored electricity usage to the electricity usage budget or information associated therewith for the predetermined time period; and
limiting electricity use within the electrical system for a predetermined limitation time period according to predetermined rules if the monitored electrical usage is greater than the electrical usage budget for the predetermined time period.
   The method may further comprise:
providing an electrical demand cap;
monitoring electrical demand of the electrical system;
comparing the monitored electrical demand with the electrical demand cap;
reducing the electrical demand of the electrical system if the monitored electrical demand is greater than the electrical demand cap.

In an example embodiment, the predetermined time period may be fifteen minutes. It follows that the predetermined limitation time period may also be fifteen minutes.

The method may comprise limiting the electricity usage and electrical demand by one or a combination of switching pre-selected or non-essential electrical devices off, limiting a percentage of electricity supplied to the electrical system. The method may comprise limiting a percentage of electricity supplied to the electrical system by way of phase angle control or burst fire control.

The method may comprise receiving information indicative of real-time electricity usage of the electrical system. The method may comprise receiving information indicative of instantaneous current demand of the electrical system.

According to a second aspect of the invention there is provided an electricity management system for an electrical system, the electricity management system comprising:
a database storing at least electricity usage budget information for the electrical system, the electricity usage budget information being associated with at least a desired or predetermined electricity usage in a predetermined time period;
an electricity monitoring module arranged to monitor electricity usage in the electrical system periodically at time intervals corresponding to the predetermined time period;
a comparator module arranged to compare the monitored electricity usage to the electricity usage budget or information associated therewith for the predetermined time period; and
an electricity limiting module arranged to limit electricity use within the electrical system for a predetermined limitation time period according to predetermined rules if the monitored electrical usage is greater than the electrical usage budget for the predetermined time period.

The system may comprise a receiver module arranged to receive information indicative of real-time electricity usage and instantaneous current demand.

### BRIEF DESCRIPTION OF THE DRAWINGS

FIG. 1 shows a block diagram of a system comprising an electricity management system in accordance with an example embodiment;

FIG. 2 shows a block diagram of the electricity management system of FIG. 1 in greater detail;

FIG. 3 shows a block diagram of the system of FIG. 1 illustrating another electricity management system in accordance with an example embodiment; and

FIG. 4 shows a flow diagram of a method of electricity management in accordance with an example embodiment.

### DESCRIPTION OF PREFERRED EMBODIMENTS

In the following description, for purposes of explanation, numerous specific details are set forth in order to provide a thorough understanding of an embodiment of the present disclosure. It will be evident, however, to one skilled in the art that the present disclosure may be practiced without these specific details.

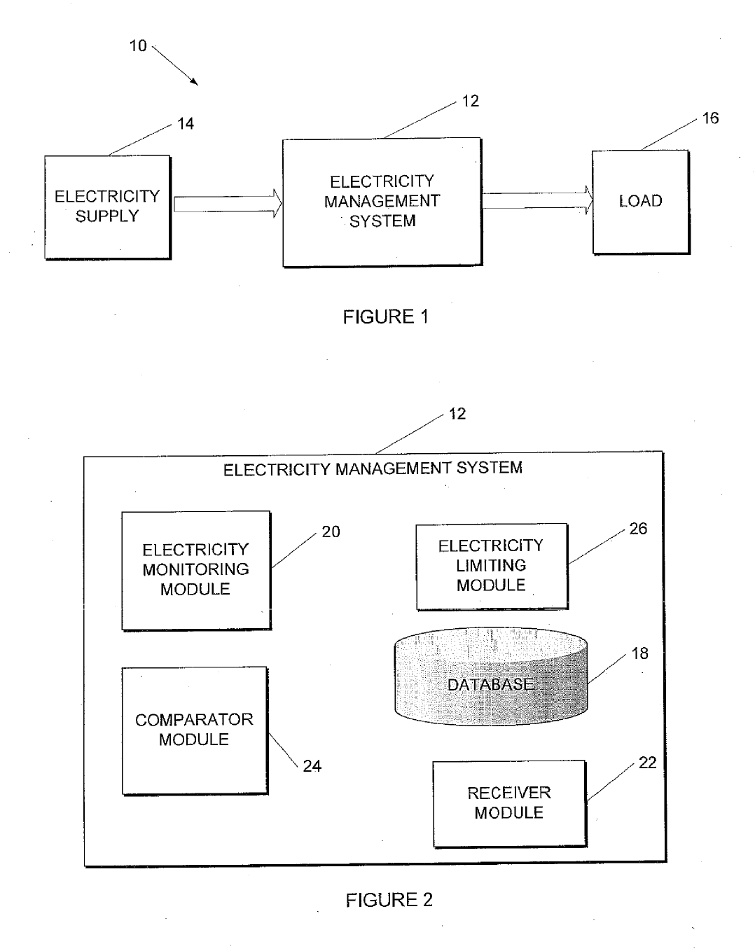

Referring to FIGS. 1 to 3 of the drawings, a system in accordance with an example embodiment is generally indicated by reference numeral 10. The system 10 comprises an electricity management system 12 in accordance with an example embodiment. The electricity management system 12 is typically arranged to manage electricity usage within a building or premises (not shown). The building may typically be associated with a household, business, factory, or the like. It follows that the system 12 may therefore be operatively disposed between an electricity supply 14, for example a municipal electricity supply, and a load 16 which may be an electrical system associated with the building.

In a preferred example embodiment, the system 12 may be embodied in a device which may be fitted to the electrical system 16 of the building. Instead, or in addition, the system 12 may be located at a remote location such that the system 12 is arranged to receive information associated with the electricity supply 14 and manage usage of electricity within the building remotely.

The system 12 may comprise a plurality of components or modules which correspond to the functional tasks to be performed by the system 12. In this regard, “module” in the context of the specification will be understood to include an identifiable portion of code, computational or executable instructions, data, or computational object to achieve a particular function, operation, processing, or procedure. It follows that a module need not be implemented in software; a module may be implemented in software, hardware, or a combination of software and hardware. Further, the modules need not necessarily be consolidated into one device but may be spread across a plurality of devices.

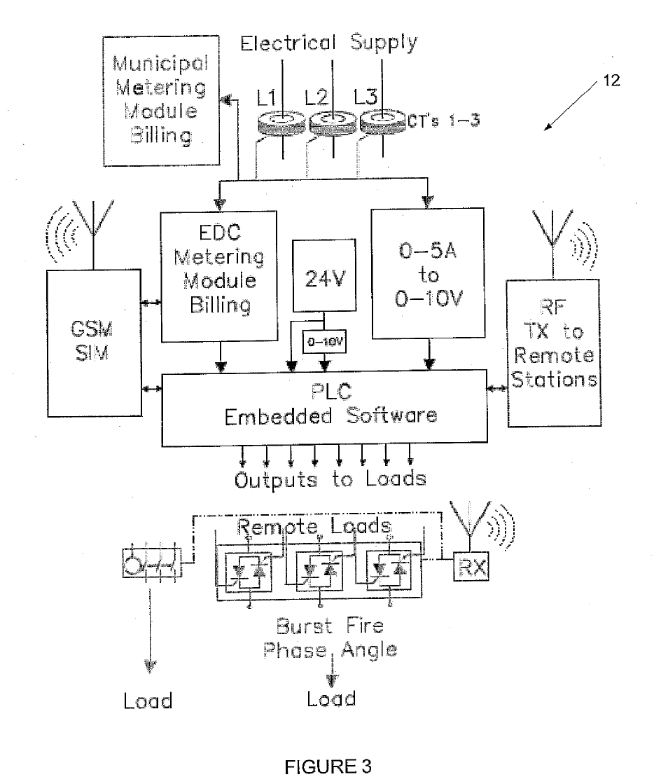

At least some of the components or modules of the system 12 may be provided in a PLC (Programmable Logic Controller) (FIG. 3).

In particular, the electricity management system 12 comprises a database 18 storing at least electricity usage budget information for the electrical system 16, the electricity usage budget information being associated with at least a desired or predetermined electricity usage in a predetermined time period. In this way the system aims to control the overall energy (kWh) usage by allocating a specific electrical usage budget per minute

The electricity usage budget may be selected by the business and may be associated with a maximum electricity usage for a financial amount specified by the business for the predetermined time period. The predetermined time period may be a fifteen minute time period.

The database 18 also comprises information indicative of a demand cap associated with electricity demand. This calculated demand cap is a level of overall demand, typically measured in kVA which will still allow the processes of the business to continue and will not impact on the turnover or revenue capacity of the business. This demand cap is typically also calculated for a predetermined period but this is usually a much larger period than the time intervals described below. This period is typically a weekly demand cap, a monthly demand cap or an annual demand cap.

The database 18 may comprise a plurality of registers arranged to store data as will be described below.

The system 12 also comprises an electricity monitoring module 20 arranged to monitor electricity usage and demand in the electrical system 16 periodically at time intervals corresponding to the predetermined time period, for example every fifteen minutes.

It follows that the system 12 advantageously comprises a receiver module 22 communicatively coupled to the monitoring module 20. The receiver module 22 is arranged to receive information indicative of at least real-time electricity usage (kWh—kilowatt hour) and instantaneous current demand.

In one example embodiment, the receiver module 22 is communicatively coupled to the electrical supply 14 via current transformers L1, L2, and L3 (FIG. 3) and a municipal metering module such that the system 12 receives the electricity supply and/or demand information and tariffs respectively. The tariffs may be those which the municipality, building landlord or electricity supplier uses thereby facilitating parity in electricity management as herein described.

The receiver module 22 may be arranged to receive real-time electricity usage in the form of a 1-kWh pulse train from a metering module (FIG. 3), and a 0-10V analogue signal (in direct relation to the 0-5 A current transformer readings) which reflects the instantaneous current (Amperage) demand of the premises.

Instead, or in addition, the system 12 may be arranged to receive the demand (kVA—kilovolt-ampere) and to convert the received demand to a 0-10V scale which is a scaled decimal representation of the instantaneous electrical demand which may be easier for the system 12 to process. In an example embodiment, the kVA (demand) is a 0.692 mathematical function of the instantaneous current supplied to the premises. The sensing current transformers will relay the instantaneous current value to the system 12. The instantaneous current value stands in a 0.692×I(instantaneous) mathematical relationship to determine the kVA (demand).

The system 12 will react on the kVA reaching the “cap” value—limiting or disconnecting current flow to nominated apparatus (discussed below).

In addition, the receiver module 22 is arranged to receive weighted averages for energy (kWh) and demand (kVA), which information is routed to energy budget and demand cap registers in the database 18. Weighted averages are based on a 24-month usage and demand profile factored with seasonality and peak trading periods. Weighted Averages are explained as follows:

1) A minimum of 12 consecutive billed meter readings for energy (kWh) and demand (kVA) must be available. 24 consecutive billed meter readings will induce a mathematically more stable model.

2) Trading peaks and seasonal factors are “weighted” into the calculation. For example the period 10 to 24 December will normally yield high foot traffic—[high density seasonal shopping]. This will place a higher electrical energy demand on the premises but the resulting turnover will allow the premises to “absorb” the extra energy and demand costs.

3) The system 12 will automatically, in a pre-programmed manner, allow the premises to trade at this higher energy and cost levels.

4) The client must, however, concede or request this pre-programmed event—if not, the system 12 will “budget” the energy and “cap” the demand.

The system 12 also comprises a comparator module 24 arranged to compare the monitored electricity usage to the electricity usage budget or information associated therewith for the predetermined time period. In particular, the kWh pulse train, received from the metering module, is placed in a counting register. As the counter increases, the comparator module 24 compares the counting register with a monthly preset financial value equivalent of the 15-minute budget register. In particular, system 12 comprises a kWh counter arranged to receive the 1-kWh pulses from the electricity meter. The comparator module 24 is set up with a pre-determined “budget” register—this is a decimal count value [X]. The counter is an up-counter which is arranged tot sum the pulses received from the meter [Y]. After receiving each pulse, the comparator module 24 compares the decimal value in the up-counter with the decimal value in the “budget” register. If X=Y then the “green cycle” (described below) is triggered—hence a pre-determined sequence of actions to reduce energy usage will be actioned.

Similarly, the comparator module 24 is also arranged to compare the monitored or received instantaneous demand with the predetermined demand cap. In particular, the instantaneous demand is continuously compared to the monthly preset financial value equivalent of the demand cap. The system 12 kVA “cap” receives the kVA from the current transformers [mathematically derived from current] and is stored as a 0-10V value [X]. In this regard, the comparator module 24 is set up with a pre-determined “cap” register—this is a 0-10V value [Y]. The comparator 24 is arranged to compare the two 0-10V values. It follows that if X=Y then the demand cap sequence is triggered—hence a pre-determined sequence of actions to reduce the demand (kVA) will be actioned.

The system 12 further comprises an electricity limiting module 26 arranged to limit electricity use within the electrical system 16 for a predetermined limitation time period according to predetermined rules if the monitored electrical usage is greater than the electrical usage budget for the predetermined time period. The predetermined limitation time period may also be fifteen minutes or in other words a 15-minute “green cycle or period”.

Similarly, the electricity limiting module 26 is arranged to unload demand, in a predetermined sequence to ensure adherence to the financial input parameters if the instantaneous demand exceeds the demand cap. It will be noted that the demand cap has a different unloading sequence that the “green cycle” (described below). However, at some premises they are the same or similar.

The electricity limiting module 26 is arranged to limit electricity usage during the “green cycle” by one or a combination of at least the following predetermined rules:

1) Switching a non-essential device or apparatus off.

2) Applying a percentage of the required energy and demand by means of phase angle control.

3) Applying a percentage of the required energy and demand by means of burst fire control.

The module 26 may be arranged to use the “best effort” of 1 to 3 above to optimise the electrical demand and energy usage of the electrical system 16 of the building.

For a business (for example a retail business), and associated building or premises, the average day trading cycle of the retail premises is 10 hours and the evening cycle is 14 hours. There are 40×15-minute monitoring checks during the day trading which can result in a maximum of 20×“green cycle” periods.

The evening cycle has 56×15-minute monitoring budget checks during non-trading which can result in a maximum of 28×“green cycle” periods.

It will be appreciated that the present invention seeks at least to address electricity costs of a business by:

1) Reducing the overall demand (kVA) to a calculated capped level which will still allow all the processes of business operation to continue and without impacting on the turnover or revenue capacity of the business.

2) Reducing the overall energy (kWh) usage by allocating a specific electrical usage budget per 15-minute time period, then monitor the usage in that 15-minute time period and then apply a 15-minute “green cycle” or period of reduced energy usage to ensure that the predetermined monthly electrical energy cost remains within the preset budget.

3) The on-board metering module ensures that the correct and most applicable tariffs are always applied to the demand and energy cost calculation. Electrical tariffs link the energy and demand to costs by simple mathematical induction:
kWh×rate=cost
kVA×rate=cost

In an example embodiment, a 15-minute period of normal energy usage will be:
0.000347222×Rand cost monthly budget

It will be appreciated that a trading month will always yield 720 hours. Day and evening trading need to be accounted for—but on average the following mathematical model will hold for all applications:
15/[720×60]=0.00034722 which is the mathematical factorial equivalent of 15 trading minutes
15—being the 15-minute window period for trading or green cycle
720—being the trading hours per month
60—being minutes per hour

As previously explained, the system 12 may be arranged to accept weighted factors for specific trading periods ,in particular, seasonality and peak trading periods are factored into the equation to compensate for extra demand and usage during defined “high” trading periods.

The system 12 has a GSM communication module (FIG. 3) on board for dynamic, on-line control and reporting via SIM and PIN secure technology platforms. This allows remote operation and control of the system by a field operator or from a control centre.

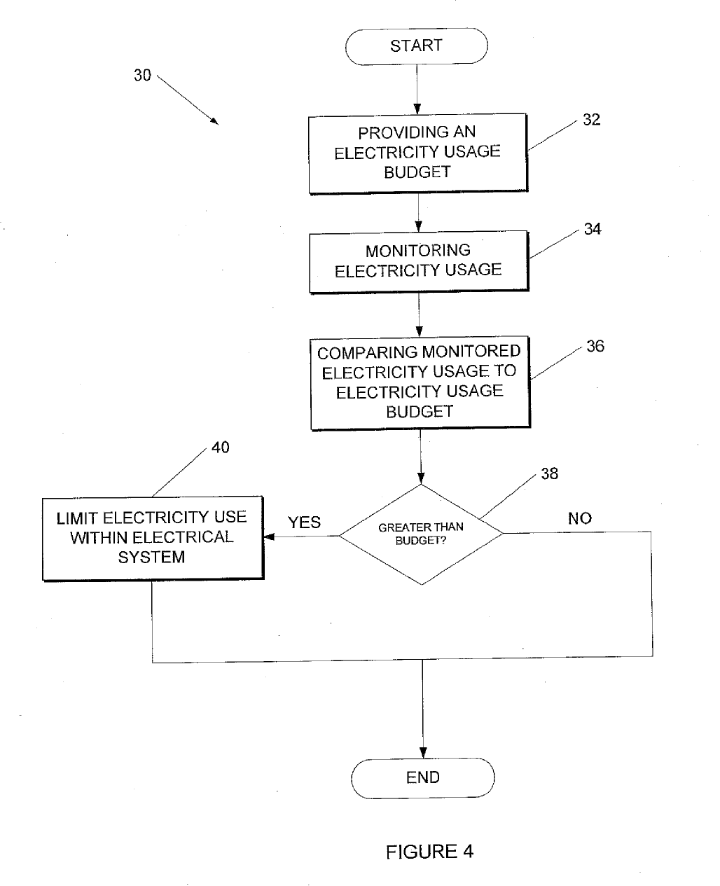

Example embodiments will now be further described in use with reference to FIG. 4. The example method shown in FIG. 4 is described with reference to FIGS. 1 to 3, although it is to be appreciated that the example methods may be applicable to other systems (not illustrated) as well.

Referring to FIG. 4 of the drawings where a flow diagram of a method for managing electricity usage of an electrical system 16 is generally indicated by reference numeral 30.

The method 30 comprises providing, at block 32 in the database 18, an electricity usage budget for the electrical system 16 as hereinbefore described for fifteen minute intervals. As previously mentioned the electricity usage budget is advantageously selected by a business depending on its financial needs. It follows that the electricity usage budget may be selected in financial terms and may be translated into an electricity amount (kWh and/or kVA) in accordance with available tariff structures received from the municipal metering module (FIG. 3).

In an example embodiment, the method 30 may comprise storing the electricity usage budget as well as demand cap information in the database 18. This calculated demand cap is a level of overall demand, typically measured in kVA which will still allow the processes of the business to continue and will not impact on the turnover or revenue capacity of the business.

The method 30 also comprises monitoring, at block 34 via the monitoring module 20, electricity usage in the electrical system 16 periodically at fifteen minute intervals. Similarly the method 30 comprises monitoring demand in the electrical system 16. It follows that the method 30 may comprise receiving electricity usage and demand, or information indicative thereof, via the receiver module 22 as hereinbefore described.

The method 30 may comprise comparing, at block 36 by way of the comparator module 24, the monitored electricity usage to the electricity usage budget or information associated therewith for the fifteen minute interval. Similarly the method 30 may comprise comparing demand with demand cap information stored in the database.

If the monitored electrical usage is greater than the electrical usage budget for the predetermined time period, then the method 30 comprises limiting, at block 40 by way of the module 26, electricity use within the electrical system 16 by applying a green cycle of fifteen minutes as hereinbefore described.

It follows that a similar application of the green cycle occurs if the instantaneous demand exceeds the demand cap. It will be noted that the kVA demand cap can occur at any time, the demand continuously monitored and demand is offloaded as and when it exceeds the demand cap. However, the “green cycle” can only occur after a 15 minute interval.

The invention as hereinbefore described provides a convenient and intelligent way to limit the amount of electricity used by a building or premises without affecting the operation of a business or household occupying the building greatly. The invention advantageously conserves energy and saves costs. In an example embodiment, the system as hereinbefore described uses inherent or stored thermodynamic capacity of an appliance or process to reduce the applied electricity to that appliance or process.

1. A method for managing electricity usage of an electrical system, the method comprising:
providing an electricity usage budget for the electrical system, the electricity usage budget being associated with at least a desired or predetermined electricity usage in a predetermined time period;
monitoring electricity usage in the electrical system periodically at time intervals corresponding to the predetermined time period;
comparing the monitored electricity usage to the electricity usage budget or information associated therewith for the predetermined time period; and
limiting electricity use within the electrical system for a predetermined limitation time period according to predetermined rules if the monitored electrical usage is greater than the electrical usage budget for the predetermined time period.

2. A method according to claim 1, the method further comprising:
providing an electrical demand cap which is an overall demand capped level;
monitoring electrical demand of the electrical system;
comparing the monitored electrical demand with the electrical demand cap; and
reducing the electrical demand of the electrical system if the monitored electrical demand is greater than the electrical demand cap.

3. A method according to claim 1 wherein the predetermined time period is fifteen minutes.

4. A method according to claim 1 wherein the predetermined limitation time period is fifteen minutes.

5. A method according to claim 1 wherein the method further comprises limiting the electricity usage and electrical demand by one or a combination of switching pre-selected or non-essential electrical devices off, limiting a percentage of electricity supplied to the electrical system and limiting a percentage of electricity supplied to the electrical system by way of phase angle control or burst fire control.

6. A method according to claim 1 wherein the method further comprises receiving information indicative of real-time electricity usage of the electrical system.

7. A method according to claim 1 wherein the method further comprises receiving information indicative of instantaneous current demand of the electrical system.

8. An electricity management system for an electrical system, the electricity management system comprising:
a database storing at least electricity usage budget information for the electrical system, the electricity usage budget information being associated with at least a desired or predetermined electricity usage in a predetermined time period;
an electricity monitoring module arranged to monitor electricity usage in the electrical system periodically at time intervals corresponding to the predetermined time period;
a comparator module arranged to compare the monitored electricity usage to the electricity usage budget or information associated therewith for the predetermined time period; and
an electricity limiting module arranged to limit electricity use within the electrical system for a predetermined limitation time period according to predetermined rules if the monitored electrical usage is greater than the electrical usage budget for the predetermined time period.

9. A system according to claim 8 wherein the system further comprises a receiver module arranged to receive information indicative of real-time electricity usage and instantaneous current demand.

10. A system according to claim 8 wherein:
the database further stores electrical demand cap information which is an overall demand capped level;
the electricity monitoring module further monitors electrical demand of the electrical system;
the comparator module compares the monitored electrical demand with the electrical demand cap; and
if the monitored electrical demand is greater than the electrical demand cap then the electricity limiting module limits the electricity use within the electrical system for a predetermined period.

11. A system according to claim 8 wherein the predetermined time period is fifteen minutes.

12. A system according to claim 8 wherein the predetermined limitation time period is fifteen minutes.

13. A system according to claim 8 wherein the electricity limiting module limits the electricity usage and electrical demand by one or a combination of switching pre-selected or non-essential electrical devices off, limiting a percentage of electricity supplied to the electrical system and limiting a percentage of electricity supplied to the electrical system by way of phase angle control or burst fire control.
